(19) United States
(12) Patent Application Publication
(10) Pub. No.: US 2015/0107474 A1
(43) Pub. Date: Apr. 23, 2015

(54) HIGH RESOLUTION CONDUCTIVE PATTERNS HAVING LOW VARIANCE THROUGH OPTIMIZATION OF CATALYST CONCENTRATION

(71) Applicant: UNIPIXEL DISPLAYS, INC., The Woodlands, TX (US)

(72) Inventor: Ed S. Ramakrishnan, The Woodlands, TX (US)

(73) Assignee: Unipixel Displays, Inc., The Woodlands, TX (US)

(21) Appl. No.: 14/398,657

(22) PCT Filed: Apr. 15, 2013
(86) PCT No.: PCT/US2013/036636

§ 371 Date: Nov. 3, 2014

Related U.S. Application Data
(60) Provisional application No. 61/642,500, filed on May 4, 2012.

(51) Int. Cl. C09D 11/107; C09D 11/03; C09D 133/08; B41F 5/24

(52) U.S. Cl. CPC C09D 11/107; B41F 5/24; C09D 11/03; C09D 133/08
USPC 101/483; 524/560

(57) ABSTRACT

An ink composition for flexographic printing having an acrylic polymer at a viscosity of 100 cps to 10,000 cps and an organometallic catalyst at a concentration of 1 wt % to 12 wt %.

### CROSS-REFERENCE TO RELATED APPLICATION

The present application claims priority to U.S. Provisional Patent Application No. 61/642,500, filed on May 4, 2012 (Attorney Docket No. 2911-03900); which is hereby incorporated herein by reference.

### BACKGROUND

Conventional methods of manufacturing transparent thin film antennas and other conductive patterns that may be used in electronics or other industries comprise screen printing a thick film with conductive paste of copper/silver, resulting in wide (>100 μm) and tall (>10 μm) lines. Photolithography and etching processes are used for thinner and narrower features.

### SUMMARY

In an embodiment, an ink composition for flexographic printing having an acrylic polymer at a viscosity of 100 cps to 10,000 cps and an organometallic catalyst at a concentration of 1 wt % to 12 wt %.

In another embodiment, a method for printing high resolution conductive patterns includes printing, by a flexographic process, on at least one side of a substrate, a plurality of lines using an ink comprising an acrylic resin and an organometallic catalyst, the ink at a viscosity of 10 cps to 2000 cps. The process also includes curing the ink and plating the ink with an electroless salt.

In yet another embodiment, an ink for printing high resolution conductive patterns includes an acrylic polymer, an organometallic catalyst at a concentration of 3 wt % to 12 wt %, and the ink is at a viscosity of 200 cps to 10,000 cps.

### BRIEF DESCRIPTION OF THE DRAWINGS

For a detailed description of exemplary embodiments of the invention, reference will now be made to the accompanying drawings in which:

FIG. 1 depicts illustrations of isometric views of flexoplates according to embodiments of the disclosure;

FIGS. 2A and 2B are illustrations transparent single and multi-loop RF antennae according to embodiments of the disclosure;

FIG. 3 is an illustration of a method of printing high resolution patterns on a substrate according to embodiments of the disclosure; and

FIG. 4 is a flow chart of a method of printing high resolution patterns on a substrate according to embodiments of the disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present disclosure relates to a method of roll-to-roll printing of high resolution conducting patterns (HRCPs) and to the composition and characteristics of the ink used when printing narrow, high aspect ratio lines. The method generally utilizes a polymer ink used to define a pattern that is subsequently electroless plated. The polymer ink may be used as part of a flexographic manufacturing process. Discussed herein are ink compositions at various viscosities and with various catalyst concentrations that may be employed in a printing process such as flexographic printing. In certain instances, the ink comprises palladium or a similar catalyst as an acetate or oxalate salt. The polymer ink may be an acrylic ink or similar polymer. Additionally, certain ink formulations may comprise organometallic compounds. In certain methods, ultrasonic stirring during dissolution of the organometallic acetate particles and other materials directly into the polymeric ink are used during preparation of the ink. These organometallic materials may not be ready for electroless plating after printing and may require activation, for example, in the form of curing. As such, these organometallic compounds are treated by ultraviolet light, heat, or other means to convert the compounds to their elemental metal form by dissociating the catalytic compound through exposure to the curing method. The electroless plating process may be conducted in a water-based chemical bath, where copper (Cu), nickel (Ni), tin (Sn), gold (Au), silver (Ag) or other metallic-salt based chemicals are present.

Also disclosed herein are inks and ink compositions for printing narrow, high aspect ratio lines by direct printing methods, including flexographic or gravure printing techniques. The acrylic polymer ink may contain either an acetate or oxalate catalyst at a concentration of 1 wt % to 12 wt % and the ink may have a viscosity of 100 centipoise (cps) to greater than 10,000 cps. The ink may be used in the direct printing and manufacturing of narrow, high aspect ratio HRCPs, 1 to 50 microns in width, having aspect ratios of 5 to 250. The ink may be printed with the systems and methods as described herein.

### Roll-to-Roll Manufacturing Process

Flexography is a form of a rotary web letterpress where relief plates are mounted on to a printing cylinder. These relief plates, which may also be referred to as a master plate or a flexoplate, may be used in conjunction with ink fed from an anilox or other two roller inking system. The anilox roll may be a cylinder used to provide a measured amount of ink to a printing plate. The ink may be heat or ultraviolet (UV) curable. In one example, a first roller transfers ink from an ink pan or a metering system to a meter roller or anilox roll. The ink is metered to a uniform thickness when it is transferred from the anilox roller to a plate cylinder. When the substrate moves through the roll-to-roll handling system from the plate cylinder to the impression cylinder, the impression cylinder applies pressure to the plate cylinder which transfers the image on to the relief plate to a transparent flexible substrate. In some embodiments, there may be a fountain roller instead of the plate cylinder and a doctor blade may be used to improve the distribution of ink across the roller.

HRCPs may be manufactured by means of a roll-to-roll manufacturing process similar to the process just described. The process may comprise activating an electroless plating catalyst contained in the polymer ink. This may be achieved by means of ultraviolet ionizing radiation or thermal curing of the printed patterns. The ink making process may utilize ultrasonic agitation to dissolve metal acetate particles directly into the acrylic base polymer ink or other binding resins. These inks are used for printing high definition patterns that are further processed into conductive electrodes. The conductive electrodes may be used inr multiple electronic applications including RF antenna structures and arrays, as well as microscopic high resolution patterns used in touch screens such as capacitive and resistive touch screen sensors.

To initiate the roll-to-roll manufacturing process, the transparent flexible substrate may be transferred via any known roll-to-roll handling method from an unwind roll to a first cleaning station. It should be appreciated that the thickness of transparent flexible substrate may be chosen in combination with a plurality of process parameters such as line speed and pressure in order to avoid excessive tension during the printing process resulting in dimensional changes by elongation. Temperature-induced dimensional changes may be considered as well since any such changes to temperature may result in changes to the printed dimensions.

The alignment, printing, and processing of the HRCPs may impact the final product performance. In accordance with various embodiments a positioning cable may be employed to maintain the alignment of and guide the transparent flexible substrate to a first cleaning at a first cleaning station that may comprise a high electric field ozone generator employed to remove impurities, for example oils or grease, from the transparent flexible substrate. The transparent flexible substrate may then undergo a second cleaning at a second cleaning station, which may be a web cleaner.

After the second cleaning, the transparent flexible substrate may go through a first printing station where a high resolution pattern (HRP) is printed. The HRP may comprise, for example, a plurality of lines for a touch screen circuit, or circuitry for a planar, dipole, transparent single loop antenna on a first surface of the transparent flexible substrate. The amount of ink transferred from the first master plate to the transparent flexible substrate may be regulated by a high precision metering system, and may depend on the speed of the process, the ink composition and viscosity, as well as the shape and dimensions of the HRP.

The pattern printed at the first printing station may be, for example, a single antenna loop. Conventionally, multiple curing steps may be required in order to activate the ink after the pattern is printed at the first printing station prior to the plating process described below. If the catalyst is underexposed, the dissociation of the organometallic catalyst may be incomplete and the plating process may be compromised. However, if the substrate is overexposed, the substrate may embrittle and compromise the integrity of the finished product, or render the substrate unsuitable for further processing.

In another embodiment, if the pattern printed at the first printing station is a planar, dipole, low visibility single antenna, then a second planar, dipole, low visibility multiple loop antenna pattern may be printed a at second printing station on the bottom side of the transparent flexible substrate. The bottom side of the transparent flexible substrate may pass through a second printing station which may use a second master plate and a organometallic compounds of palladium ink to print the multiple loop antenna . The amount of ink transferred from a second master plate to the bottom side of the transparent flexible substrate may also be regulated by a second high precision metering system. In some embodiments, a plurality of flexoplates may be used in at least one of the first or the second printing stations. In those embodiments, there may be a plurality of inks used for each flexoplate of the plurality of flexoplates depending upon the shape and geometry of the patterns printed at the first and the second printing stations.

The bottom side printing at the second printing station may be followed by a second curing station. The second curing station may comprise a second ultraviolet cure as described above, with about the same target intensity at about the same wavelength. In addition, the second curing station may further comprise a heating module that applies heat within a temperature range of about 20° C. to about 85° C. to the substrate.

### Electroless Plating

The first and the second patterns printed on the top and the bottom (or first and second) sides of the substrate may be a single loop antenna printed on the top (first) surface of the transparent flexible substrate and an antenna with a plurality of loops printed on the bottom (second) surface of the substrate. In one example, both patterns may be printed with organometallic compounds of palladium or other catalyst-based ink. Other organometallic catalysts may be used that are acetates or oxalates of palladium, rhodium, platinum, copper, or nickel. As referred to herein, the catalyst in the ink is used to aid in the electroless plating of the HRP. Additionally, however, the catalyst may also aid in viscosity stabilization and in reducing variations of the printed line widths.

The entire substrate that contains both patterns may then undergo electroless plating at a plating station. During plating, the seed catalyst acts as a receptor, or nucleation site, and enables the plating metal (for example, copper, nickel, palladium, aluminum, silver, and gold) to react and adhere to the HRPs. Without the nucleation sites, the plating solution may not activate. Additionally, If the catalyst, and by extension the nucleation sites, is not uniform in the HRPs, incomplete plating may occur resulting in breaks in the metal and highly resistive HRCPs.

In some embodiments, organometallic materials such as palladium acetate or palladium oxalate may not be ready to plate and may have further treatment to convert the compounds in the printed pattern to their metal form. Further treatment may be performed because the activation of the ink means that the organometallic compounds of palladium are dissociated from non-metallic form to metallic form. The further treatment may comprise dissociating the compounds through exposure to ultraviolet radiation with a broad spectrum, the wavelength used may be maintained between about 365 nm and about 435 nm. As discussed above, if the catalyst is underexposed, i.e., not sufficiently dissociated, the electroless plating process may be compromised and the pattern may not be plated properly, uniformly, or completely leading to continuity problems or highly resistive HRCPs.

Depending upon the composition of the ink, the activation process may not maintain the integrity of the pattern and, therefore, the printed pattern and the plated pattern may not have the same dimensions, a problem that may be more pronounced where the printed patterns have small dimensions. However, a second curing step may not be needed if the concentration of the organometallic is between 1 wt. %-20 wt. % and if the parameters used for the first curing step are sufficient to cure the printed pattern when the organometallic ink is used. It should be appreciated that the substrate properties may conform the curing parameters, for example, if the pattern or patterns are cured for too long, or if one pattern is printed and cured and a second pattern is printed and cured, the same substrate may be cured twice under two full curing cycles or processes. As a result, the substrate may embrittle and/or experience discoloration and therefore may not maintain its desired properties such as flexibility, transparency, and strength.

The curing time and/or energy density may vary depending upon the organometallic content (wt %) of the ink and on the thickness of the HRPs. A higher percentage of organometallics may require a more intense curing to dissociate the organometallic. Further, narrow, high aspect ratio lines may require more curing to ensure the UV radiation or heat reach and dissacociate In that scenario, in addition to ultraviolet curing, the organometallics may be dissociated by an additional heat cure. This dissociation may occur upon what is referred to as the activation of the organometallic compound. Activation is when the organometallic, such as organometallic compounds of palladium, is dissociated from the compound form to the metallic form and the metallic form becomes conducive to plating such that the metallic palladium act as nucleation sites for plating to precipitate. It should be appreciated that, even though the catalyst in the ink dissociates, the dissociation does not cause dimensional distortion, which preserves the as-printed pattern dimensions and uniformity for the plating process.

After printing the top and, in some cases, bottom patterns on the transparent flexible substrate, the substrate may be submerged into an electroless plating tank that contains copper or other conductive material so that the HRPs are plated resulting in HRCPs. The thickness of the plated metal may depend on the plating solution temperature and the speed of the web, which may be varied according to the application. The electroless plating at the plating station does not require the application of electric current and only plates the patterned areas containing the catalyst in the ink that were previously activated in the process. The plating thickness may be more uniform compared to electroplating due to the absence of electric fields. Electroless plating may be well suited for parts with complex geometries and/or many features, like those exhibited by printed transparent antenna patterns circuitries.

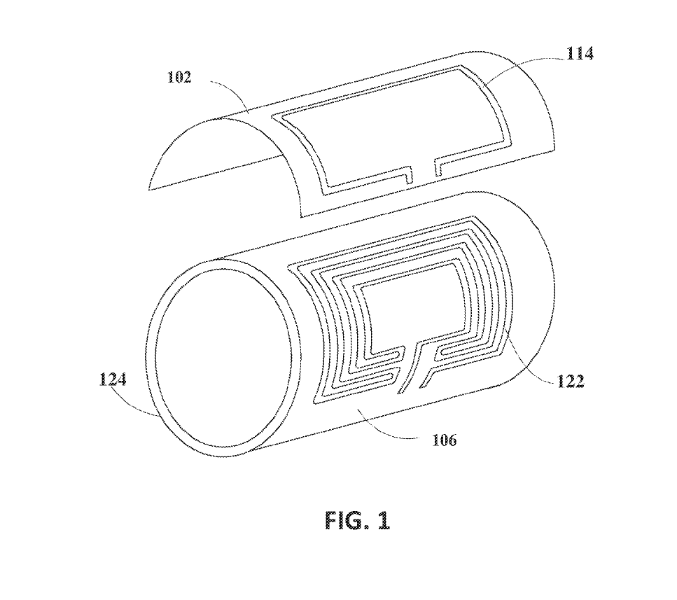

After electroless plating, the flexible substrate with both patterns, may go through a washing process comprising submerging the printed substrate into a cleaning tank that contains deionized water. The printed substrate may be subsequently dried at a drying station. To protect the conductive material of the antenna patterns against corrosion, a passivation station may be used to passivate the patterns. FIG. 1 is an illustration of an isometric view of a flexomaster according to various embodiments of the present disclosure.

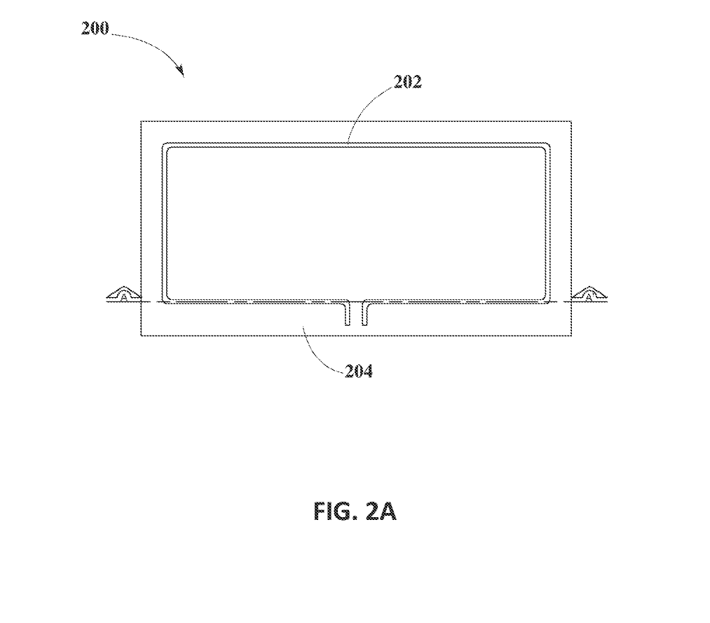

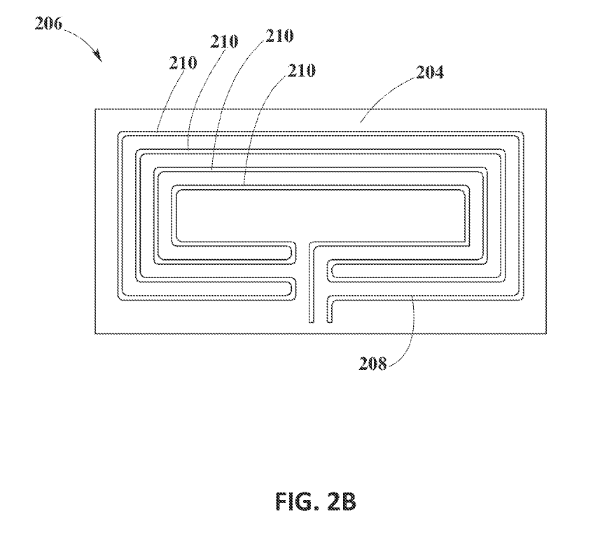

FIG. 1 illustrates flexomaster patterns 102 and 106. In accordance with various embodiments, a top flexomaster 102 is mounted on the roll 124 and used in conjunction with a printing system, for example a metered printing system, to print the transparent single loop antenna 114 on the top surface of a flexible substrate such as pictured in FIG. 2A. The bottom flexomaster 106 is employed to print the transparent multiple loops antenna 122, which may also be referred to as the second or bottom pattern, comprising a plurality of loops on the bottom surface of the transparent flexible substrate. It should be understood that the use of the words “top” and “bottom” herein is to reflect two different sides of a substrate and may be used interchangeably with “first” and “second,” and are not necessarily used in reference to the orientation of a substrate or final product. In an embodiment, the pattern 122 may be similar to the pattern discussed below in FIG. 2B. In an embodiment, the flexomaster 102 and the flexomaster 106 are separately patterned flexoblanks that are each disposed on a different roll.

In this embodiment, the rollers, such as the roller 124, may be arranged in series wherein the first pattern created by 114 is printed on the top surface of the substrate and the multiple loop antenna pattern 122 is printed on the bottom surface of the substrate opposite of the first pattern 114. In an alternate embodiment, the rollers may be arranged such that the first pattern and the second pattern are printed by two different flexomasters on two different rolls and both patterns are printed on one substrate wherein the first pattern 114 is printed on the top (first) surface and the second pattern 122 is printed on the bottom (second) surface. While the example of the antennas are provided herein, this method may also be applied to the manufacture of touch screen sensors and other high resolution conductive patterns where a single substrate or multiple substrates may be printed and assembled. In this example, the printing may occur simultaneously or in series as part of an in-line process. In another example, at least one of the top pattern or the bottom pattern is formed by a plurality of flexoplates disposed on a plurality of rolls. This may occur, for example, because the desired end pattern is designed with varying transitions, dimensions, and geometries that may make it appropriate to use more than one ink, which would then mean that more than one roll may be used. In another example, multiple rolls may be used to create one pattern because the pattern geometry, transitions, or dimensions are more uniformly printed in stages.

The height of the printed conductive lines in both the transparent single loop antenna 114 and the transparent multiple loops antenna 122 may vary from 100 nm to 7 microns, while the distance between each pair of conductive lines might vary from 10 microns to 5 mm. The height as used herein refers to the distance between the substrate and the top of the printed pattern. The thickness of the material layer employed to create a master for the top flexomaster 102 and the bottom flexomaster 106 may range between 0.5 mm and 3.00 mm. In some embodiments, the flexomaster 106 may be an offset flexomaster which is backed on one side by a metallic siding which may be as thin as 0.1 mm.

FIGS. 2A and 2B are illustrations of top views of planar dipole transparent antenna structures according to embodiments of the present disclosure. In FIG. 2A, a planar dipole transparent antenna structure 200 may be designed for radiating or receiving wireless electromagnetic signals, as required in telecommunication applications. The antenna structure 200 may comprise a planar, dipole transparent single loop rectangular antenna 202 disposed on a transparent, flexible substrate 204. This type of antenna design exhibits a conductive line width that may vary from about 1 micron to about 30 microns, representing a dimension range that may produce a transparent effect to the naked eye, depending to the distance from the user. The printed micro electrodes (line or lines) of the transparent single loop rectangular antenna 202 may exhibit a light transmission efficiency of about 60% or greater. The conductive electrodes might be constructed of gold plated copper, silver plated copper, or nickel plated copper. The copper is plated over to provide passivation for corrosion resistance.

The resistivity of the printed electrode on the transparent single loop rectangular antenna 202 may range from about 0.005 micro-Ohms per square to about 500 Ohms per square, while the length of the printed electrode may vary from about 0.01 m to about 1 m, depending on the frequency range of the end application, which may range from about 125 KHz to about 25 GHz.

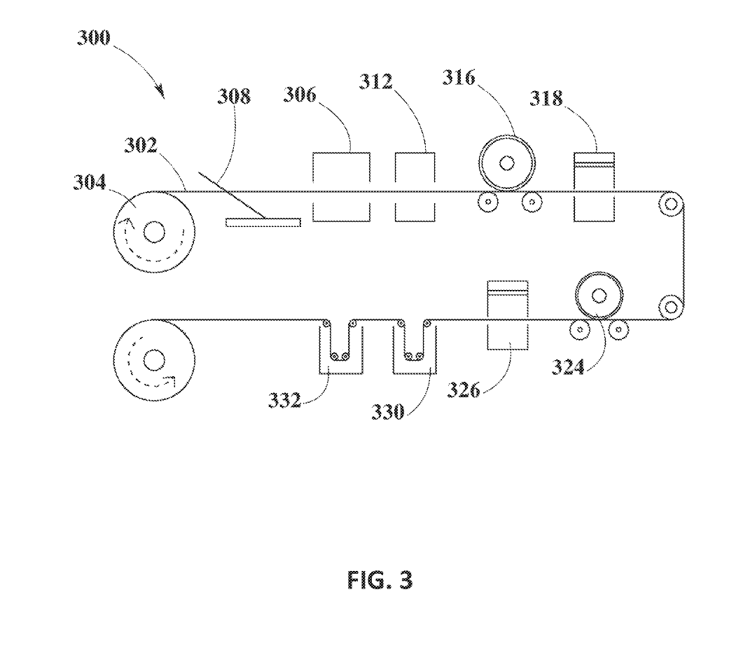

In general, materials that may be used for the transparent flexible substrate 102 include polyethylene terephthalate (PET) film, polycarbonates, and polymers. Specifically suitable materials for the transparent flexible substrate 102 may include the DuPont/Teijin Melinex 454 and DuPont/Teijin Melinex ST505, the latter being a heat stabilized film specially designed for processes where heat treatment is involved and where dimensional changes are not acceptable for the process. The transparent flexible substrate 102 may exhibit a thickness between 5 and 500 microns, with a preferred thickness between 100 microns and 200 microns. A detailed method of manufacturing transparent antenna circuits using roll-to-roll process is depicted in FIG. 3 and described herein.

The transparent antenna structure 200 might be designed in any pattern geometry, or array of antenna patterns, that can be adjusted individually to suit different frequencies or channels to receive or transmit terrestrial broadcasting as well as satellite broadcasting and radio signals, required for telecommunication application. In other embodiments, the transparent antenna structure 200 may be used along with reflective elements to increase the directivity of the radiation pattern.

FIG. 2B is an illustration of a multi-loop antenna structure according to embodiments of the present disclosure. The multi-loop antenna structure 206 comprises a pattern 208 that comprises a plurality of loops 210. In an embodiment, the plurality of loops may also be referred to as a loop array and the features may be described as concentric even if they are formed by a single, continuous, line. In an embodiment, the features may be rectangular in shape. In alternate embodiments, the features may be circular, square, triangular, or a combination thereof and the features may be referred to as loops regardless of the geometric shape or number of individual lines used.

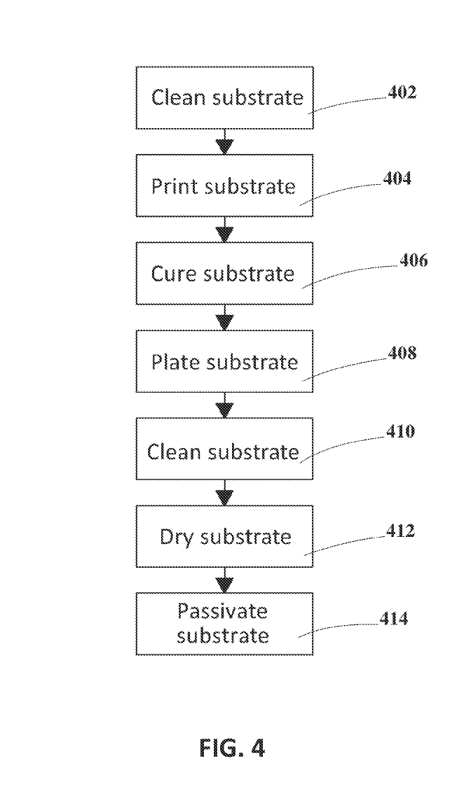

FIG. 3 is an illustrative system used to manufacture HRCPs according to embodiments of the present disclosure. FIG. 4 is a flowchart of a method of manufacturing HRCPs according to embodiments of the present disclosure. A transparent flexible substrate 302 in system 300, pictured here in side-view along the process, is disposed on unwind roll 304 in a roll-to-roll process. It should be appreciated that the term transparency as used herein may also refer to the substrate with printed electrodes were the amount of light transmission through both the substrate and the HRCPs is greater than about 60%. The substrate may be any material that may be used as a base on which to print integrated circuitries, as described above.

The speed of the process may vary from about 20 ft/m to about 750 ft/m. In some embodiments, a speed of about 50 ft/m to about 200 ft/m may be suitable. In some embodiments, an alignment mechanism 308 may be used to ensure that the substrate 302 is properly aligned with respect to the in-line process. The substrate 302 may be cleaned at block 402 at first cleaning station 306 that may comprise a high electric field ozone generator or corona plasma module employed to remove impurities. In some embodiments, the transparent flexible substrate may then undergo a second cleaning at second cleaning station 312, which may be a web cleaner. The substrate 302 which comprises a first (top) and a second (bottom) side may then have the first side printed at block 404, which may correspond to printing station 316. At the first printing station 316, a HRP is printed at block 404 by a first master plate using an ultraviolet curable polymer ink that may have a viscosity from about 100 cps to greater than 10000 cps and a catalyst concentration from about 3 wt. % to 7 wt. %. In some embodiments, this HRP may form antennas with a single loop or a plurality of loops having line widths for the patterns between about 1 micron and about 30 microns.

The ink used at the first printing station may comprise acrylic monomer or polymer resin material doped with organometallic compounds of palladium. The organometallic compounds of palladium may be, for example, at a concentration of between about 1 wt. % to about 12 wt. %, preferably 3 wt. %-7 wt. %, of the acrylic resin and may serve as a plating catalyst that is activated through curing at block 406 at a first curing station 318. The curing station 318 may comprise a broad spectrum ultraviolet radiation curing with a target intensity frange from about 0.5 mW/cm²-200 mW/cm² or higher. The UV radiation wave length may be from about 250-600 nm, and, preferably, may be between 365 nm to about 435 nm. The UV energy density and/or wavelength used may be dependent on the catalyst in the ink, the density of the ink, the viscosity of the ink, the aspect ratio of the HRPs, or a combination of the listed parameters.

The UV exposure may cause two reactions to occur simultaneously—the curing (polymerization) of the acrylic resin and the dissociation of the organometallic compounds of palladium to palladium metal. The palladium metal, as described above, may form the seed layer for electroless plating. In some embodiments depending on ink composition and dimensions of printed patterns, in addition to UV, the process may consist of a heating module that applies heat within a temperature range of about 20° C. to about 130° C.

The catalyst concentration in the ink and the viscosity of the ink may affect process parameters and the quality of the resulting HRCPs. When printing narrow (1 to 50 microns in width), high aspect ratio (5 to 250 times their width) lines, the catalyst may assist with more aspects of the ink than just as a reaction site for electroless plating. For example, a HRCP of a line with of 50 microns may only need a height of 200 nanometers, whereas a line width of 5 microns may need a height of 1 micron to give the same resistance values. The catalyst concentration may assist with increasing and stabilizing the viscosity of the ink, which may allow the aspect ratios at the upper end of the given range. Additionally, the narrow lines may require higher levels of the catalyst to ensure the plating process is uniform. The narrower the line, however, the higher the aspect ratio may need to be so that plating occurs on the side walls of the printed lines. Very narrow lines may not have the requisite resistance unless the side walls are also plated. Plating on the side walls is also assisted with higher catalyst concentrations. As such, narrow lines may require an ink of high viscosity and side wall plating and both goals are enhanced by increasing the concentration of the catalyst. It should be appreciated that the concentration of the catalyst may have an upper limit over which may result in inks that may not properly polymerize during curing. On the other hand, the wider the line the less catalyst and lower viscosity may be required for the ink since the larger surface area allows the plating to propagate faster. Whereas, the finer lines may require the higher catalyst concentration to enable uniform plating without electrical discontinuity.

At either end of the line width spectrum, the inclusion of the catalyst may also affect the uniformity in line width. As noted, the catalyst may assist with viscosity stabilization, which may lead to more stable line width, or densities, post curing. Due to the curing process driving out any volatile elements in the ink, the ink may tend to shrink or deform after the curing process. To alleviate the potential deformation that results from the shrinking, the higher concentrations of the catalyst may add more structure to the ink and reduce the amount of shrinkage or deformation.

In some embodiments, a second pattern is printed at block 404 at second printing station 324. The second pattern may be cured at a second curing station 326 in a similar fashion as first curing at first curing station 318. The second pattern may be printed on the second side of the substrate 302, or adjacent to the first pattern on the first side, or on a substrate other than substrate 302. It is appreciated that both printing stations 316 and 324 may have varied configurations. Both patterns may be printed at the same time at block 404 using both printing stations 316 and 324. Alternatively, not shown in FIG. 4 but as shown in FIG. 3, the second printing station 324 prints the second pattern subsequent to the first pattern being printed at first printing station 316 and cured at first curing station 318.

In an embodiment, if the pattern printed at 316 or 324 comprises varying dimensions, transitions, and complexities of its geometry, the first or the second pattern, or both, the printing process may be adjusted to account for these aspects of one or both patterns. In another embodiment, printing stations 316 and 324 may be arranged such that the first pattern is printed on the first surface of the substrate 302 and the second pattern is created on the bottom side of the substrate 302 either simultaneously or in series in the in-line process. In this example, one substrate is patterned with two patterns, which may be different in geometry and may have been printed in different inks. In another embodiment, printing stations 316 and 324 may be arranged wherein the first pattern is printed on the first side of the substrate 302 and the second pattern is printed on the first side of substrate 302 adjacent to the first pattern. In another embodiment, at least one of the first of the second printing stations 316 and 324 comprise more than one flexoplate disposed on more than one roll as discussed in FIG. 1. In another example, multiple rolls may be used to create one pattern because the pattern geometry, transitions, or dimensions are more uniformly printed in stages, or because the multiple roll process per pattern may allow higher run speeds for the inline process.

Subsequent to printing, the patterns printed at 316 and 324 are plated, for example, by electroless plating 408. Electroless plating 408 at plating station 330 may be well suited for parts with complex geometries and/or many features, like those exhibited by printed transparent antenna patterns. During electroless plating at plating station 330, a conductive material such as copper (Cu) is deposited on the pattern. In some embodiments other conductive material such as silver (Ag), nickel (Ni), or aluminum (Al) may be used. The plating occurs in a fluid medium comprising the conductive material at a temperature range between about 20° C. and about 90° C. In an embodiment, the same conductive material may be used on the patterns printed at 316 and 324, and in another embodiment different conductive materials may be used on the patterns. The activated pattern(s) attract the conductive material to form a HRCP.

In certain instances, the liquid medium of the plating bath is at about 80° C., for example, depending on the metal therein. In one example, copper may be at a temperature from 35° C.-45° C., and in another example, nickel may be between 65° C.-80° C. The deposition rate may be between about 10 nm to about 200 nm per minute, with a final thickness achieved of about 10 nm-5000 nm (0.01 microns-5 microns). In an alternate example, the final thickness achieved by plating may be from about 10,000 nm-100,000 nm (10 microns-100 microns). The thickness of the plating on the pattern, which may also be referred to as the thickness of the plated pattern, may depend on the plating solution temperature and the speed of the web which may be varied according to the application. The electroless plating at the plating station does not require the application of electrical current and only plates the patterned areas containing a plating catalyst that were previously activated through ionizing ultraviolet radiation curing exposure. The plating thickness may be more easily controllable and therefore more uniform compared to electroplating due to the absence of electric fields.

After electroless plating, both patterns, may go through a washing process, which may also be referred to as another cleaning 410, at a wash station 332 which may be a dip or a spray (not pictured) station. The dip wash station 332 comprises submerging the patterns plated at plating station 330 into a cleaning tank that contains water at room temperature. The patterns may be subsequently dried 412 a drying station (not pictured) by applying air at room temperature. In some embodiments, in order to protect the conductive material of the RF antenna circuitries against corrosion, a passivation station (not shown in FIG. 3) may be used to passivate 414 the substrate and may be a pattern spray added after drying to prevent any undesired reaction between the conductive materials and water.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An ink composition for flexographic printing, comprising:
an acrylic polymer at a viscosity of 100 cps to 10,000 cps; and
an organometallic catalyst at a concentration of 1 wt % to 12 wt %.

2. The ink of claim 1, wherein the acrylic polymer is at a viscosity of 200 cps to 2000 cps.

3. The ink of claim 1, wherein the organometallic catalyst is at a concentration in the ink of 3 wt % to 7 wt %.

4. The ink of claim 1, wherein the organometallic catalyst is organometallic compounds of palladium.

5. The ink of claim 1, wherein the viscosity is 1200 cps.

6. The ink of claim 1, wherein the organometallic catalyst is a compound containing copper.

7. A method for printing high resolution conductive patterns, comprising:
printing, by a flexographic process, on at least one side of a substrate, a plurality of lines using an ink comprising an acrylic resin and an organometallic catalyst, the ink at a viscosity of 10 cps to 2000 cps;
curing the ink; and
plating the ink with an electroless salt.

8. The method of claim 7, wherein the organometallic catalyst is at a concentration in the ink of 1 wt % to 8 wt %.

9. The method of claim 7, wherein the organometallic catalyst is organometallic compounds of palladium.

10. The method of claim 7, wherein the viscosity of the ink is 200 cps.

11. The method of claim 7, wherein the viscosity of the ink is 1200 cps.

12. The method of claim 7, wherein each line of the plurality of lines are 1 micron to 100 microns wide.

13. The method of claim 7, wherein the height of each line of the plurality of lines are 0.2 microns to 2 microns.

14. The method of claim 7, wherein the electroless salt is a copper containing solution.

15. The method of claim 7, wherein the electroless salt is a nickel containing solution.

16. An ink for printing high resolution conductive patterns, comprising:
an acrylic polymer;
an organometallic catalyst at a concentration of 3 wt % to 12 wt %; and
wherein the ink is at a viscosity of 200 cps to 10,000 cps.

17. The ink of claim 16, wherein the viscosity is 1200 cps and the concentration of the organometallic catalyst is 3 wt % to 7 wt %.

18. The ink of claim 16, wherein the organometallic catalyst is organometallic compounds of palladium.

19. The ink of claim 16, wherein the organometallic catalyst is a copper compound.

20. The ink of claim 16, wherein the organometallic catalyst is a nickel compound.
